(19) United States
(12) Patent Application Publication
(10) Pub. No.: US 2024/0428294 A1
(43) Pub. Date: Dec. 26, 2024

(54) Parking Reservation Verification System and Method

(71) Applicant: Productive Application Solutions, Inc., Sheridan, WY (US)

(72) Inventors: Peter Ta, Tucson, AZ (US); Gerald Maliszewski, San Diego, CA (US)

(21) Appl. No.: 18/827,729

(22) Filed: Sep. 7, 2024

Related U.S. Application Data
(63) Continuation-in-part of application No. 17/830,783, filed on Jun. 2, 2022, now abandoned.
Application No. 17/830,783 is a continuation-in-part of application No. 17/830,412, filed on Jun. 2, 2022.
Application No. 17/830,412 is a continuation-in-part of application No. 17/230,008, filed on Apr. 14, 2021, now Pat. No. 11,270,349.
Application No. 17/230,008 is a continuation-in-part of application No. 17/201,419, filed on Mar. 15, 2021, now Pat. No. 12,112,352.
Application No. 17/201,419 is a continuation-in-part of application No. 17/179,574, filed on Feb. 19, 2021, now Pat. No. 11,257,120.
Application No. 17/179,574 is a continuation-in-part of application No. 17/168,313, filed on Feb. 5, 2021, now Pat. No. 12,106,327.
Application No. 17/168,313 is a continuation-in-part of application No. 17/133,722, filed on Dec. 24, 2020, now Pat. No. 11,055,743.
Application No. 17/133,722 is a continuation-in-part of application No. 17/097,256, filed on Nov. 13, 2020, now Pat. No. 11,887,163.
Application No. 17/097,256 is a continuation-in-part of application No. 17/071,043, filed on Oct. 15, 2020, now Pat. No. 11,037,199.
Application No. 17/071,043 is a continuation-in-part of application No. 17/023,546, filed on Sep. 17, 2020, now Pat. No. 10,991,007.
Application No. 17/023,546 is a continuation of application No. 17/007,575, filed on Aug. 31, 2020, now Pat. No. 11,468,477.
Application No. 17/007,575 is a continuation of application No. 16/869,696, filed on May 8, 2020, now Pat. No. 10,803,488.
Application No. 16/869,696 is a continuation of application No. 16/601,362, filed on Oct. 14, 2019, now Pat. No. 10,796,340.
(60) Provisional application No. 63/310,857, filed on Feb. 16, 2022.
(60) Provisional application No. 62/779,972, filed on Dec. 14, 2018.

(51) Int. Cl. G06Q 30/0251; G05D 1/226; G05D 1/689; G06F 16/487; G06Q 30/0242

(52) U.S. Cl. CPC G06Q 30/0266; G05D 1/226; G05D 1/689; G06F 16/487; G06Q 30/0244; G06Q 30/0252; G06Q 30/0267

(57) ABSTRACT

A system and method are disclosed for vehicle parking reservations that provides a map software application including a plurality of publically accessible vehicle parking location listings. A parking reservation application accepts vehicle parking location reservation requests and then matches vehicle parking location reservation requests with vehicle parking location listings. In response to matching, a reservation order position is transmitted to a mobile unit. The mobile unit may be a self-powered vehicle, towable vehicle, portable station, or autonomous vehicles. A mobile unit parking application compares the reservation order position to a mobile unit geographic location, and automatically transmits a tamper-proof automated reservation confirmation, without any human intervention, once the mobile unit occupies the reservation order position. In some circumstances, the parking reservation application may accept a vehicle parking location reservation request from a first entity even though the mobile unit is associated with a second entity, independent of the first entity.

### RELATED APPLICATIONS

Any and all applications, if any, for which a foreign or domestic priority claim is identified in the Application Data Sheet of the present application are hereby incorporated by reference under 37 CFR 1.57.

### BACKGROUND OF THE INVENTION

### Field of the Invention

This invention generally relates to the control of public access vehicle parking locations and, more particularly, to a system and method for matching parking reservations to available listings and using mobile platforms to occupy publically accessible stationary locations.

### Description of the Related Art

As of this writing there is no fast and convenient way of reserving and procuring spaces that are generally available to the public, such as parking spaces along a highway. In the event of an emergency, government employees can be used to secure locations. However, it can difficult to schedule employees to perform emergency tasks that come up without warning, especially if they work on an hourly basis.

For the average driving it can be difficult to be assured that a parking space will be available when they reach their destination, especially in high traffic density urban areas. Likewise, for businesses that relies upon the control of street frontage or street occupation, there is no assurance that a desired remote street frontage will be available when needed.

It would be advantageous if desirable publically accessible locations and parking spots could be reserved using gig economy vehicles.

It would be advantageous if the parking spot reservations could be made in advance to use, so as the guarantee their availability when needed.

It would be advantageous if a driver could select from a plurality of available parking reservations.

It would be advantageous if parking reservations could be used to block off parking spots for public service events.

### SUMMARY OF THE INVENTION

In the interest in furthering the technologies concerning driving and parking, a method is disclosed herein for vehicle parking reservations that provides a map software application including a plurality of publically accessible vehicle parking location listings. A parking reservation software application accepts vehicle parking location reservation requests and then matches vehicle parking location reservation requests with vehicle parking location listings. In one aspect, the parking reservation application cross-references vehicle parking location listings to types of mobile units that may be parked at those locations. In response to a match, a reservation order position is transmitted to a mobile unit. The mobile unit may be a self-powered vehicle, towable vehicle, portable station, or ground vehicles. The mobile unit may be a nautical vehicle in the case of the reservation order position being a slip or anchorage, or an airborne vehicle if it can maintain a stationary position. In some aspects the mobile unit is an autonomous vehicle.

A mobile unit parking software application compares the reservation order position to a mobile unit geographic location, and automatically transmits a tamper-proof automated reservation confirmation, without any human intervention, once the mobile unit occupies the reservation order position. To promote gig economy vehicle use, in some circumstances the parking reservation application may accept a vehicle parking location reservation request from a first entity even though the mobile unit is associated with a second entity, independent of the first entity. After a mobile unit occupies a reservation order position for a time, the parking reservation application may supply a vacation (release) order to the mobile unit, ordering the mobile unit to cease occupying the reservation order position. The mobile parking application then provides a release verification to the parking reservation application in response to the mobile unit leaving the reservation order position, thus making the position available to a different mobile unit or permitting the location listing to be designated as vacant. Once parked in the reservation order position, a mobile unit transfer subsystem may permit the occupation of the mobile unit by an entity, other than an entity associated with the request or the mobile unit.

In one aspect the mobile unit comprises environment sensors to receive local environmental data from devices such as cameras, microphones, weather sensors, odor sensors, LIDAR, radar, sonar, forward looking infrared (FLIR), photodetectors, chemical sensors, wireless spectrum receiver, wireless service traffic analyzer, radiation sensor, air quality monitor, and combinations thereof. In another aspect, the method provides a valuation table cross-referencing vehicle parking location listings to weighted values. The mobile unit may transmit the local environmental data so that the valuation table weighted values can be updated in response to the local environmental data.

For example, the parking reservation system may be enabled as an online dashboard that permits the reservation of a publically accessible stationary location, such as a parking spot along a public highway, a parking lot, or a parking ramp. In some aspects, the dashboard also permits the selection of mobile unit types, and/or the times that the stationary location is to be occupied by a reserving mobile unit.

Additional details of the above-described method and a system for vehicle parking control system are provided below.

### BRIEF DESCRIPTION OF THE DRAWINGS

FIG. 1 is a schematic block diagram of a vehicle parking control system.

FIG. 2 is a diagram depicting a scouting subsystem that may work in conjunction with the parking control system of FIG. 1.

FIG. 3 is a plan view diagram depicting an exemplary scouting subsystem in use.

FIGS. 4A through 4F depict some exemplary mobile units.

FIG. 5 is a plan view of geographic regions cross-referenced to the weighted value of various positions.

FIG. 6 is a flowchart illustrating a method for vehicle parking reservations.

### DETAILED DESCRIPTION

Due to the high volume of traffic in urban areas and limited parking availability, novel parking schemes, such as described herein, are required to meet the needs of public service organizations and even the average citizen driver. The parking reservation system described herein use a system of cooperating devices to offer multiple parking options through the use of partnered organizing and “capturing” entities, so that even remotely located parking spaces can be ordered in advance of their use. Through the use of cooperating machines, human error is eliminated, providing a guaranteed reliable performance in the reservation process and an accurate verification that the ordered parking space is actually being occupied in compliance with the parking space order. Since the steps performed by this system cannot reasonably be performed by a human, the system can now rightly be referred to as a type of traffic or parking technology.

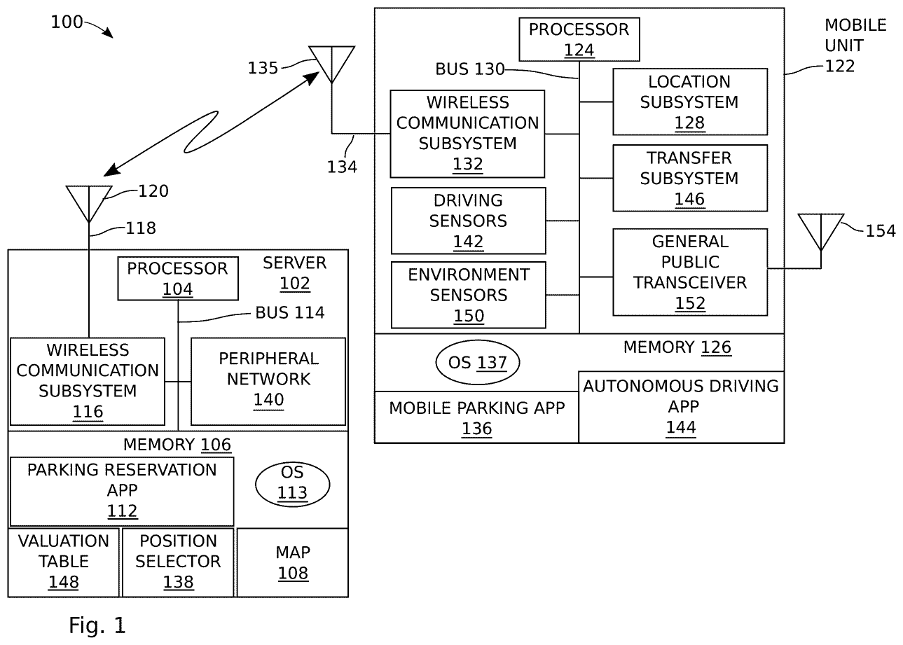

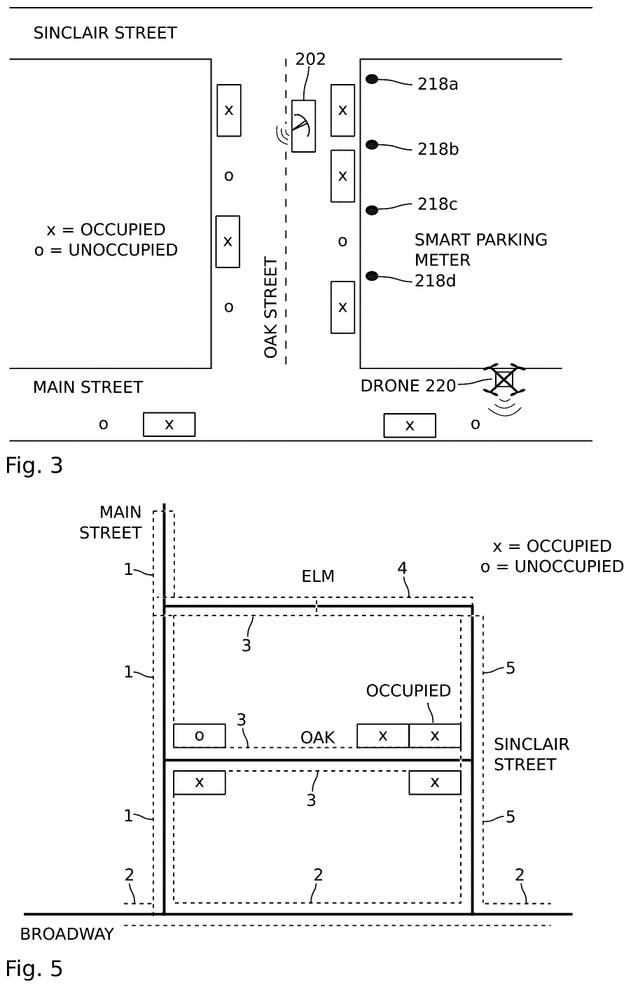

FIG. 1 is a schematic block diagram of a vehicle parking control system. The system 100 comprises a server 102 with a processor 104 and a non-transient memory 106. A map software application 108 is embedded in the memory, and it includes a plurality of publically accessible vehicle parking location listings 110. For example, the location listings may be for parking spaces along a public thoroughfare (see FIG. 3). A parking reservation software application 112 is also embedded in the memory 106 with operating system (OS) 113. The parking reservation application 112 comprises an interface on line 114 for accepting vehicle parking location reservation requests, and instructions for matching vehicle parking location reservation requests with vehicle parking location listings and as a result, providing a reservation order position. In one aspect, the parking reservation application 112 cross-references vehicle parking location listings to types of mobile units. For example, one set of parking location listings may be reserved for recreation vehicles, and a different set of parking location listings for motorcycles. The parking reservation application interface 114 also receives a reservation confirmation, as explained below.

A wireless communications system 116 has an interface on line 114 to receive the reservation order position, and an interface 118 (connected to antenna 120) to transmit the reservation order position and receive the reservation confirmation from a mobile unit 122. The mobile unit 122 may, for example, be a self-powered vehicle, towable vehicle, portable station, or any type of ground vehicles. If the reservation order position is a slip or anchorage, the mobile unit 122 may be a nautical vehicle, or an airborne vehicle if it is able to maintain a stationary position.

The mobile unit 122 is remotely positioned from the server 102 and comprises a processor 124 and a non-transient memory 126. As used herein, the term “remote” means that the mobile unit is typically out of sight of the server. A location system 128 provides mobile unit geographic locations on line 130. A wireless communications system 132 has an interface 134 (connected to antenna 135) to receive the reservation order position and to transmit the reservation confirmation to the server, and an interface on line 130 to supply the reservation order position to a mobile parking software application 136 embedded in the mobile unit memory 126 with OS 137. The mobile parking application 136 comprises an interface on line 130 for accepting the reservation order position and mobile unit geographic locations. The mobile parking application 136 compares the reservation order position to the (current) mobile unit geographic location, and provides the reservation confirmation, tamper-proof automated to prevent human intervention, when the mobile unit 122 occupies the reservation order positon. That is, any entity associated with the mobile unit is unable to interact with the mobile parking application, and more explicitly, is unable to send, delete, or modify the reservation confirmation. The reservation confirmation is made tamper-proof to promote confirmation veracity, by preventing intentional or accidental confirmation corruption by a mobile unit associated entity. That is, the reservation confirmations acts as a guarantee that the mobile unit occupies the intended position. The mobile unit wireless communications subsystem 132 transmits the reservation confirmation to the server wireless communications subsystem 116, where it is then relayed to the parking reservation application 112.

In one aspect, the vehicle parking location reservation request is sourced by a first entity. The first entity may be an automated position selector, shown for simplicity as a server software application 138 embedded in memory 106. The automated position selector may include long term requests, or make requests using machine learning “educated guesses” based on prior requests. Alternatively, the request may be submitted by the first entity via a peripheral or network interface 140. The parking reservation application 112 may also accept suggested additions to the vehicle parking location listings, if the suggested addition is not already present in the vehicle parking location listings. The mobile platform 122 may also be associated with the first entity. However, in some aspects, such as in support of gig economy vehicles, the mobile unit 122 may be associated with a second entity, independent of the first entity.

The mobile unit 122 may also be equipped with driving sensors 142 having an interface on line 130 to supply traffic data. Examples of driving sensors include radar, sonar, and LIDAR, to name a few conventional examples. The driver sensors are not limited to merely these examples. In this case an autonomous driving software application 144 embedded in the mobile unit memory 126 comprises an interface to accept the traffic data and an interface on line 130 to supply driving control instructions to mobile unit mechanisms (e.g., steering, braking, acceleration) for autonomously navigating the mobile unit along public thoroughfares.

In another aspect, the parking reservation application 112, subsequent to the mobile unit 122 occupying the reservation order position, supplies a vacation (release) order to the mobile unit ordering the mobile unit to cease occupying the reservation order position. The mobile parking application 136 provides a release verification to the parking reservation application 122 (via the wireless subsystems 116 and 132) in response to the mobile unit leaving the reservation order position, thus making the position available to a different mobile unit or permitting the location listing to be designated as vacant.

Once parked in the reservation order position, a mobile unit transfer subsystem 146 may permit the occupation of the mobile unit by an entity, other than an entity associated with the request or the mobile unit. In this case, the entity permitted occupation of the mobile platform is typically not the entity associated with (e.g., owning) the mobile unit. For example, the transfer subsystem 146 may be a vehicle lock/unlock mechanism, remotely controlled by the parking reservation application 112, that permits an entity to enter the mobile unit 122, or an ignition control mechanism that permits an entity to drive the mobile unit. One use for this feature would be for the delivery of rental vehicles to locations convenient for pickup or drop off.

In one aspect the server 102 further comprises a valuation table software application 148 embedded in server memory 106 cross-referencing vehicle parking location listings to weighted values. In a related feature the mobile unit 122 may further comprise environment sensors 150 to receive local environmental data from devices such as cameras, microphones, weather sensors, odor sensors, LIDAR, radar, sonar, forward looking infrared (FLIR), photodetectors, chemical sensors, wireless spectrum receiver, wireless service traffic analyzer, radiation sensor, air quality monitor, and combinations thereof. The mobile unit communication subsystem 132 may transmit the local environmental data to the server 102 so that the valuation table application receives the local environmental data and updates the weighted values in response to the local environmental data. For example, positions close to the requesting entity, or positions on busy streets (with limited parking) may have a relative high weighted value.

The mobile unit 122 may further comprise a transceiver 152 (and antenna 154) accessible to a general public, such as a cellular telephone local booster, Internet booster, an access point (AP) such as an IEEE 802.11 Wireless Local Area Network (WLAN) AP, an IEEE 802.15 Wireless Personal Area Network (WPAN) AP, or combinations thereof. One example of a publically accessible AP is the WiFi hotspot service provided by a typical Starbucks coffee shop. In the case of a password being required for access, the password may be printed on the mobile unit, or made available through the parking reservation application 112.

The non-transitory memories described herein may be any type or form of non-volatile storage device or medium capable of storing data and/or other computer-readable instructions. Examples of memories include, without limitation, Read Only Memory (ROM), flash memory, or any other suitable memory device. Although not required, in certain embodiments, the system described herein may include both a volatile memory unit and a non-volatile storage device.

As is common in many computer systems or servers, processor 104 is connected to the bus line 114 to pull operating instructions from operating system (OS) 113 and software applications in memory 106, and manage communications between the various components of the server 102. For ease of understanding, the above-described functions have been described as individual components. However, it should be understood that in practice, multiple functions may be performed by a single device, subsystem, or software application.

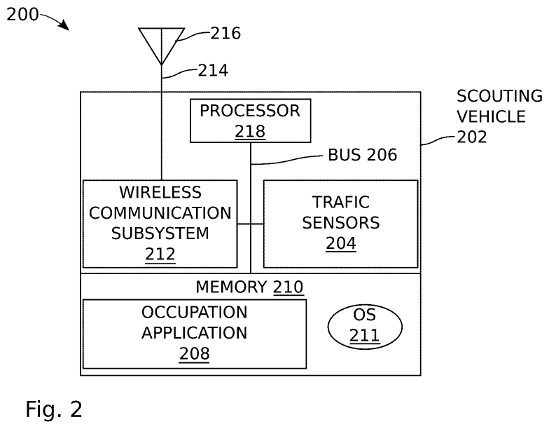

FIG. 2 is a diagram depicting a scouting subsystem that may work in conjunction with the parking control system of FIG. 1. The scouting subsystem 200 comprises a scouting vehicle 202, for example, a car or drone. Traffic sensors 204, e.g., a camera, are mounted to the scouting vehicle 202 and have an interface on line 206 for supplying scanning data to an occupation software application 208 embedded in a scouting vehicle non-transitory memory 210 with OS 211. Some of the environment and autonomous driving sensors mentioned above would also be suitable as traffic sensors 204. The occupation application 208 includes processor 218 executable instructions for determining the occupation status of a vehicle parking location listing (i.e., is the parking location available or occupied), and supplies occupation data on line 206. A wireless communication subsystem 212 has an interface on line 206 to accept occupation data and an interface 214 (via antenna 216) to report the occupation data to the server (102, see FIG. 1). The parking reservation application (112, see FIG. 1) is updated to list the availability of vehicle parking location listings in response to the occupation data. In another aspect not shown, the occupation application is embedded with the server and the scanning data is sent directly to the server for occupation analysis.

FIG. 3 is a plan view diagram depicting an exemplary scouting subsystem in use. For example, as shown, the scouting subsystem 200 may also incorporate “smart” parking meters 218a, 218b, 218c, and 218d that are able to communicate their status, which may be based on camera images or expiration time. In one aspect, city or private party operated cameras may be accessed. Otherwise, a scouting vehicle 202 reports occupation status. In one aspect, the scouting vehicle 202 is an autonomous vehicle, drone aircraft 220, or satellite that may use cameras or other sensors to identify the occupied locations (marked with an “x”) or unoccupied spaces (marked with a “∘”).

Returning to FIG. 1, some vehicle parking location listings may be known while other listings are putative stationary location. For example, an “Oceanside Marina” location listing may be considered a putative location based upon tides, local boat traffic, and the boat captain's judgement. The selection of a putative stationary location may entail the acquiescing to one of several possible nearby locations, a best effort to find an available location near a desired location, or a best effort to find an available location guaranteed to be within a predetermined radius of a desired location.

As used herein, a “stationary location” may be a parking location. “Parking” is typically understood to be location where a vehicle is temporarily left with its engine off, or if not self-powered, left without means of movement. Mobile units may be “parked” along city streets or in publicly accessible areas, such as parking lots. Mobile units are typically “parked” for limited durations of time, typically a matter of hours, but the durations can be as small as minutes or larger than even weeks. “Temporary” is understood to be typically to be a duration of several minutes to several hours, although it may also be a matter of days or even weeks. “Occupation” is understood to mean filling a space or location so completely that another vehicle or entity is unable to fill that space. In the case of drone aircraft or boats, these vehicles may need to be powered with engines running to maintain a stationary location.

If a mobile unit is already occupying the reservation order position, then the reservation order position instruction would be for the mobile unit to remain in place. As noted above, a mobile unit is capable of being possessed by an entity other than the one associated with (i.e., owning) the mobile unit. In this case the mobile unit may be equipped with a digital or physical lock, and the entity taking procession may be provided with a digital key (e.g., code) or physical key able to open the lock. The mobile unit may be equipped with sensors (e.g., a digital lock or camera) able to determine possession, and the mobile unit transmits an acknowledgement that possession has occurred. The mobile unit may also include other sensors able to determine if mobile unit amenities (e.g., a snack bar) are being used, or to determine mobile unit mobility status.

Also as noted above, the mobile unit may include a transfer subsystem that permits occupation or movement of the mobile unit subsequent to possession. For example, the mobile unit entity taking possession may be provided with a digital code that permits the entity to engage the mobile unit ignition. In one aspect, the mobile unit may act as a placeholder and is moved upon the arrival of the entity making the reservation, permitting the mobile unit to be replaced with a different mobile unit.

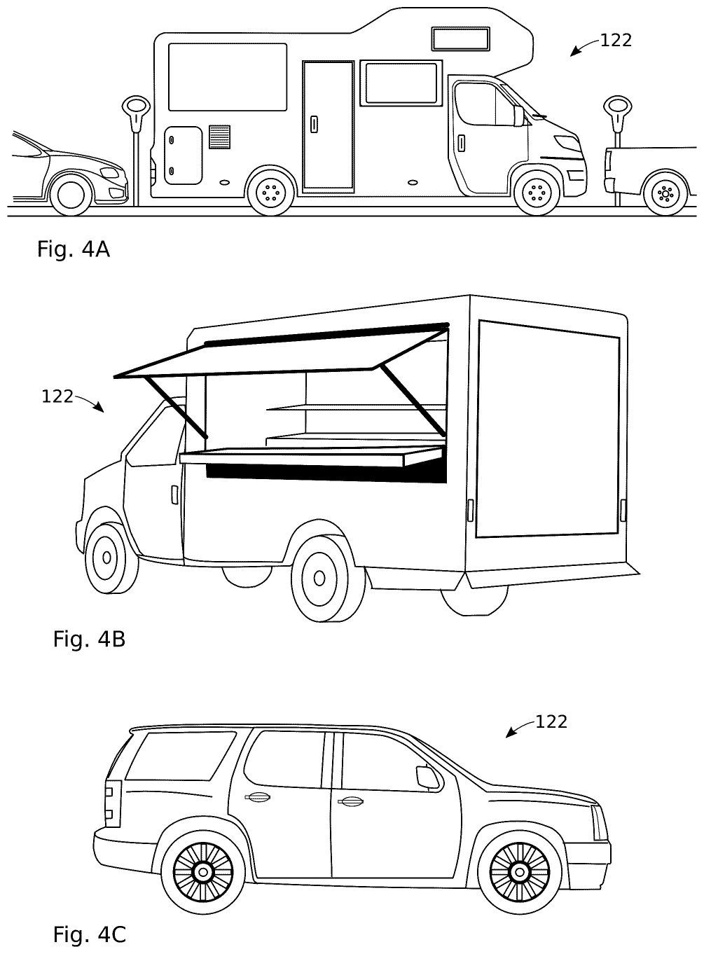

FIGS. 4A through 4F depict some exemplary mobile units. Some exemplary mobile unit types include cars, trucks, and portable stations, as explained above. Some explicit examples include a recreation vehicle (RV) (FIG. 4A), mobile kitchen or food truck (FIG. 4B), police car (FIG. 4C), boat (FIG. 4D), drone (FIG. 4E), or pod for storage, kitchen, street services, or motel (FIG. 4F). In the case of air or nautical vehicles, the launching site, landing site, or midair position may be the location that is reserved.

In one aspect, the mobile unit is able to send a message to the parking reservation application indicating the occupation of an independently selected stationary location. The parking reservation application is then updated to list the addition of the independently selected location listing. “Independently selected” refers to the ability of the mobile unit to pick its own preferred locations, such as might support the use of mobile units as a “gig” economy entity, similar to an Uber driver being able to select which destination they are willing to travel to.

As noted above, the parking reservation application may cross-reference locations listings to types of mobile units. Mobile unit types may be differentiated based upon whether they are capable of movement on the ground, air, or water. Within these categories the units may be graded on size or prestige value. In the ground category for example, users may be permitted to select between cars, luxury cars, and trucks. Or, within the air category, users may be permitted to select between drones on the basis of speed, endurance, or lifting capacity. Likewise, different types of boats may be available.

As noted above, the parking reservation application may incorporate an interface to accept requests such as the addition of a suggested stationary location to the location listings, the addition of a suggested mobile unit, or the addition of a cross-reference between a location listing and a particular mobile unit, or a mobile unit type. If the suggestions are accepted, the parking reservation application is updated in response to the requests.

Also as noted above, the server may include a valuation table. The table values may be linked to particular locations, mobile unit type, parking duration, or a combination of these variables. For example, weighted values may be established using geo-fencing services, such as provided by Radar Labs, Inc. Geo-fencing uses technologies like GPS, radio frequency identification (RFID), WiFi, cellular data, and internet protocol (IP) address ranges, to build virtual fences in geographic regions. These virtual fences can be used to track the physical location of a device active in the particular region or the fence area. The location of the device is taken as geocoding data and can be used construct a picture of IP traffic in those areas. However, the geo-fencing information used to support the above-described valuation table is typically not instantaneously updated. To support instantaneous real-time updates, the valuation table may receive geographic location local environmental data from network-connected media units. Also as noted above, a mobile unit is potentially able to supply local environmental data from a camera, microphone, odor sensor, photodetector, chemical sensor, wireless spectrum receiver (e.g., detecting the noise floor in Bluetooth, WiFi, or cellular bands), wireless service traffic analyzer (e.g., detecting traffic through a publically accessible AP or the above-mentioned geo-fencing technologies), radar, sonar, FLIR, radiation sensor, local weather sensor (e.g., temperature or rain), and/or air quality monitor.

Some examples of mobile unit location subsystems include a Global Positioning Satellite (GPS) system receiver, assisted GPS taking advantage of cell tower data, a Wireless Local Area Network IEEE 802.11 (WiFi) positioning system, cell-site multilateration, satellite multilateration, or a hybrid positioning system. Hybrid positioning systems find locations using several different positioning technologies, such as GPS, combined with cell tower signals, wireless internet signals, Bluetooth sensors, IP addresses, and network environment data. Cell tower signals have the advantage of not being hindered by buildings or bad weather, but usually provide less precise positioning. WiFi positioning systems may give very exact positioning in urban areas with high WiFi density, depending on a comprehensive database of WiFi access points. Further, a LORAN type system or LoJack® type system might be adapted for the purpose of location determination. As noted in U.S. Pat. No. 10,796,340, which is incorporated herein by reference, camera images and the location data of proximate smartphones, laptops, and personal communication devices can also be used to determine location.

Some examples of mobile unit wireless communications subsystems include cellular systems (e.g., Global System for Mobile Communications (GSM), Universal Mobile Telecommunications System (UMTS)-time division duplexing (TDD), Long-Term Evolution (LTE), 4^{th} Generation (4G), or 5^{th} Generation (5G)), and the like. Less typically, the communications subsystem may be enabled with WLAN IEEE 802.11 (WiFi), or even Long Range Wireless transceiver. Some examples of a Long Range Wireless system include Digital Enhanced Cordless Telecommunications (DECT), Evolution-data Optimized (EVDO), General Packet Radio Service (GPRS), High Speed Packet Access (HSPA), IEEE 802.20 (iBurst), Multichannel Multipoint Distribution Service (MMDS), Muni WiFi, commercial satellite, and IEEE 802.16 Worldwide Interoperability for Microwave Access (WiMAX (WiBro)).

In one aspect, an access point available to the general public can be used to collect data from entities passing by, or engaging with the access point or using the communications transceiver. This data can be stored in local memory for subsequent recovery or transmission to the server in support of data gathering or geo-fencing data. In support of data mapping, the access point is publically accessible to user devices that include smartphones, personal devices, or generally any type of computing device. Typically, the user devices are enabled for WiFi and Bluetooth communications. If left enabled, as is the typical case for many users, the user device is able to interact with a nearby access point even if a communication data link is not established. As used herein, the term data mapping includes the collection of data from the user devices. In one aspect, user data information (e.g., IP addresses) is collected voluntarily, with the user explicitly agreeing to data collection in response to an access point provided services, such as the provision of an Internet browser, email, Internet, or social media services. For example, the access point may be a WiFi hotspot that accepts Uniform Resource Locator (URL) address requests from a user device (e.g., a smartphone).

The transceiver available to the general public may also be a signal booster, such as a device provided by WeBoost, or a similarly functioning proprietary device. The booster may act as a relay between a proximately located user cellular device and a cellular network (i.e., base station or satellite). In other aspects, a signal booster acts to relay Internet signals, such as might be useful when employed with the StarLink or similar Internet service, as the StarLink ground units require an uninterrupted view of the sky (i.e., view of the StarLink satellites) For example, the mobile unit may be positioned in areas of weak cellular coverage. The mobile units can act as cellular boosters in poor coverage areas. Improved cellular coverage necessary improves Internet and WiFi services carried by the cellular service.

As used herein, an “entity” may be a person, a business, a corporation, any type of social organization or business unit, a physical device, or a software application. For simplicity, the entities may be identified as the hardware components being used by, or associated with a business, corporation, or social organization. In this case, the entity may be described as a computer, smartphone, media projection subsystem, server, or vehicle, to name a few examples.

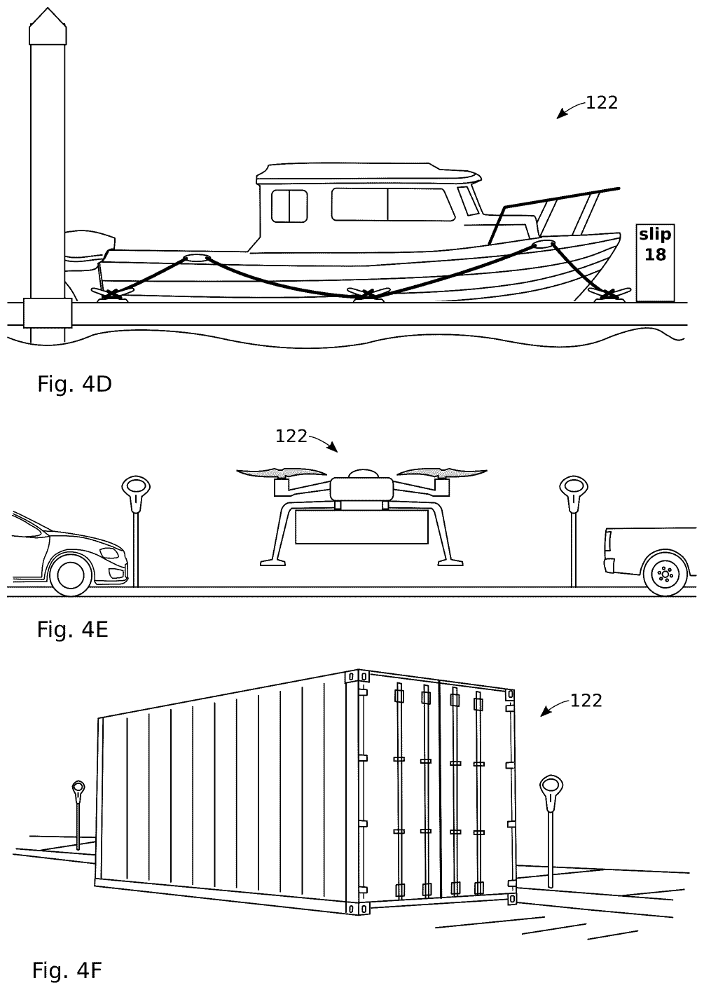

FIG. 5 is a plan view of geographic regions cross-referenced to the weighted value of various positions. As shown, regions along Main Street have a value of 1, the highest rated value. The regions along Broadway have a value of 2. The regions along Oak have a value of 3. The region along Elm near Main Street have a value of 3, which decreases to a value of 4 near Sinclair Street, and the regions along Sinclair Street have a value of 5. The parking reservation application may include a listing of occupied spaces along Oak Street (as marked with an “x”), and may list a stationary location along Oak Street (as marked with an “∘”) available for selection.

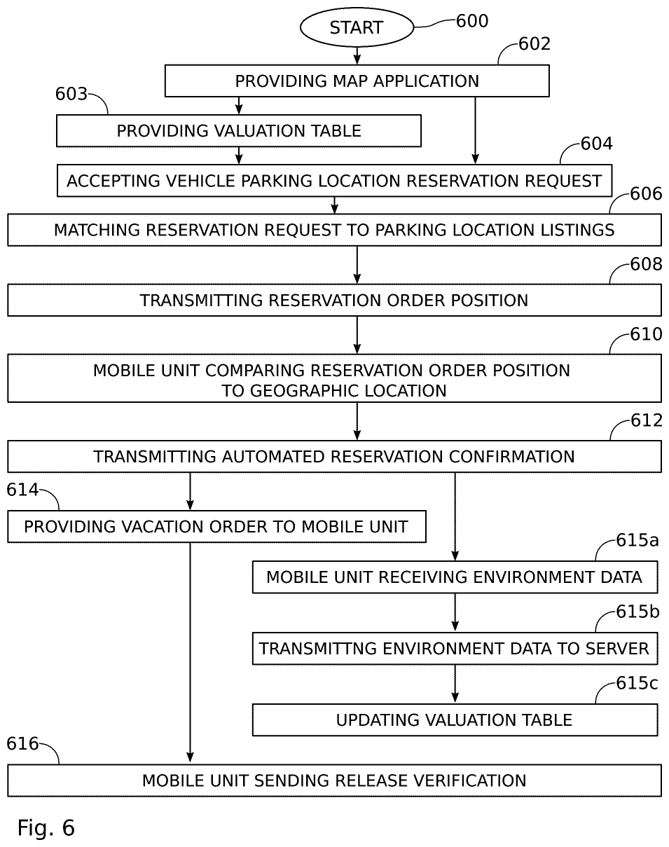

FIG. 6 is a flowchart illustrating a method for vehicle parking reservations. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method steps are supported by the above system descriptions and, generally, the method follows the numeric order of the depicted steps. The method starts at Step 600.

Step 602 provides a map software application embedded in a non-transitory server memory. The map application includes a plurality of publically accessible vehicle parking location listings. In Step 604 a parking reservation software application embedded in the memory accepts vehicle parking location reservation requests. In some aspects the parking reservation application cross-references vehicle parking location listings to types of mobile units. In Step 606 the parking reservation application matches vehicle parking location reservation requests with vehicle parking location listings. In response to the matching of Step 606, Step 608 transmits a reservation order position to a mobile unit. In Step 610 a mobile unit parking software application embedded in a non-transitory mobile unit memory compares the reservation order position to a mobile unit geographic location. In Step 612 the mobile unit parking application automatically transmits a tamper-proof reservation confirmation, without human intervention, once the mobile unit occupies the reservation order position. In one aspect, the parking reservation application accepts a vehicle parking location reservation request in Step 604 from a first entity, and the mobile unit is associated with a second entity, independent of the first entity.

In another aspect, in Step 614 the parking reservation application, subsequent to the mobile unit occupying the reservation order position, supplies a vacation order to the mobile unit ordering the mobile unit to cease occupying the reservation order position. In Step 616 the mobile parking application provides a release verification to the parking reservation application in response to the mobile unit leaving the reservation order position.

Optionally, Step 603 provides a valuation table software application embedded in the server memory that cross-references vehicle parking location listings to weighted values. In Step 615a mobile unit sensors receive local environmental data from devices such as cameras, microphones, weather sensors, odor sensors, LIDAR, radar, sonar, FLIR, photodetectors, chemical sensors, wireless spectrum receiver, wireless service traffic analyzer, radiation sensor, air quality monitor, and combinations thereof. In Step 615b the mobile unit transmits the local environmental data to the server, and in Step 615c the valuation table application weighted values are updated in response to the local environmental data.

Systems and methods have been provided for traffic control and parking reservation systems. Examples of particular message structures, schematic block linkages, and hardware units have been presented to illustrate the invention. However, the invention is not limited to merely these examples. Other variations and embodiments of the invention will occur to those skilled in the art.

We claim:

1. A vehicle parking control system comprising:
a server comprising:
a processor;
a non-transient memory;
a map software application embedded in the memory including a plurality of publically accessible vehicle parking location listings;
a parking reservation software application embedded in the memory comprising an interface for accepting vehicle parking location reservation requests, with processor enabled instructions for matching vehicle parking location reservation requests with vehicle parking location listings, providing a reservation order position, and subsequently receiving a reservation confirmation;
a wireless communications system having an interface to accept the reservation order position, and an interface to transmit the reservation order position and subsequently receive the reservation confirmation from a mobile unit;
the mobile unit remotely positioned from the server comprising:
a processor;
a non-transient memory;
a location system having an interface to provide a mobile unit geographic location;
a wireless communications system having an interface to receive the reservation order position and to subsequently transmit the reservation confirmation to the server, and an interface to supply the reservation order position to a mobile parking software application; and,
the mobile parking software application embedded in the mobile unit memory having an interface for accepting the reservation order position and mobile unit geographic location, and processor enabled instructions for comparing the reservation order position to the mobile unit geographic location, and providing the reservation confirmation, tamper-proof automated to prevent human intervention, when the mobile unit occupies the reservation order positon.

2. The system of claim 1 wherein the vehicle parking location reservation request is sourced by a first entity; and,
wherein the mobile unit is associated with a second entity, independent of the first entity.

3. The system of claim 1 wherein the parking reservation application, subsequent to the mobile unit occupying the reservation order position, supplies a vacation order to the mobile unit ordering the mobile unit to cease occupying the reservation order position; and,
wherein the mobile parking application provides a release verification to the parking reservation application in response to the mobile unit leaving the reservation order position.

4. The system of claim 1 wherein the mobile unit further comprises:
driving sensors having an interface to supply traffic data; and,
an autonomous driving software application embedded in the mobile unit memory comprising an interface to accept the traffic data and an interface to supply instructions for autonomously navigating the mobile unit along public thoroughfares.

5. The system of claim 1 wherein the mobile unit further comprises:
a transfer subsystem permitting the occupation of the mobile unit by an entity, subsequent to the mobile unit occupying the reservation order position.

6. The system of claim 1 wherein the mobile unit further comprises a transceiver accessible to a general public selected from the group consisting of a cellular telephone local booster, Internet booster, an access point (AP) selected from the group consisting of an IEEE 802.11 Wireless Local Area Network (WLAN) AP, an IEEE 802.15 Wireless Personal Area Network (WPAN) AP, and combinations thereof.

7. The system of claim 1 wherein the mobile unit is selected from the group consisting of self-powered vehicles, towable vehicles, portable stations, ground vehicles, nautical vehicles, and airborne vehicles.

8. The system of claim 1 wherein the parking reservation application cross-references vehicle parking location listings to types of mobile units.

9. The system of claim 1 wherein the parking reservation application has an interface to accept suggested additions to the vehicle parking location listings.

10. The system of claim 1 wherein the server further comprises:
a valuation table software application embedded in the server memory cross-referencing vehicle parking location listings to weighted values.

11. The system of claim 1 further comprising:
a scouting subsystem comprising:
a scouting vehicle;
a scouting vehicle non-transitory memory;
traffic sensors mounted on the scouting vehicle having an interface suppling scanning data;
a processor;
an occupation software application embedded in the scouting vehicle memory having an interface to accept the scanning data, and processor executable instruction for determining an occupation status of a vehicle parking location listing and supplying occupation data;
a wireless communication subsystem having an interface to accept occupation data and an interface to supply the occupation data to the server; and,
wherein the parking reservation application is updated to list the availability of vehicle parking location listings in response to the occupation data.

12. The system of claim 1 wherein the mobile unit further comprises:
environment sensors to receive local environmental data from devices selected from the group consisting of cameras, microphones, weather sensors, odor sensors, LIDAR, radar, sonar, forward looking infrared (FLIR), photodetectors, chemical sensors, wireless spectrum receiver, wireless service traffic analyzer, radiation sensor, air quality monitor, and combinations thereof.

13. The system of claim 12 wherein the mobile unit communication subsystem transmits the local environmental data to the server;
wherein the server further comprises:
a valuation table software application embedded with the server memory, cross-referencing vehicle parking location listings to weighted values; and,
wherein the valuation table application has an interface to receive local environmental data, and updates the weighted values in response to the local environmental data.

14. A method for vehicle parking reservations, the method comprising:
providing a map software application embedded in a non-transitory server memory, the map application including a plurality of publically accessible vehicle parking location listings;
a parking reservation software application embedded in the memory accepting vehicle parking location reservation requests;
the parking reservation application matching vehicle parking location reservation requests with vehicle parking location listings;
in response to matching, transmitting a reservation order position to a mobile unit;
a mobile unit parking software application embedded in a non-transitory mobile unit memory comparing the reservation order position to a mobile unit geographic location; and,
the mobile unit parking application automatically transmitting a tamper-proof reservation confirmation, without human intervention, once the mobile unit occupies the reservation order position.

15. The method of claim 14 wherein the parking reservation application accepts a vehicle parking location reservation request from a first entity; and,
wherein the mobile unit is associated with a second entity, independent of the first entity.

16. The method of claim 14 wherein the parking reservation application, subsequent to the mobile unit occupying the reservation order position, supplies a vacation order to the mobile unit, ordering the mobile unit to cease occupying the reservation order position; and,
wherein the mobile parking application provides a release verification to the parking reservation application in response to the mobile unit leaving the reservation order position.

17. The method of claim 14 wherein the parking reservation application cross-references vehicle parking location listings to types of mobile units.

18. The method of claim 14 further comprising:
providing a valuation table software application embedded in the server memory, cross-referencing vehicle parking location listings to weighted values.

19. The method of claim 14 further comprising:
mobile unit environment sensors receiving local environmental data from devices selected from the group consisting of cameras, microphones, weather sensors, odor sensors, LIDAR, radar, sonar, forward looking infrared (FLIR), photodetectors, chemical sensors, wireless spectrum receiver, wireless service traffic analyzer, radiation sensor, air quality monitor, and combinations thereof.

20. The method of claim 19 further comprising:
the mobile unit transmitting the local environmental data to the server;
providing a valuation table software application embedded in the server memory, cross-referencing vehicle parking location listings to weighted values; and,
updating the weighted values in response to the local environmental data.
